(19) United States
(12) Patent Application Publication
(10) Pub. No.: US 2001/0014563 A1
(43) Pub. Date: Aug. 16, 2001

(54) Modular jack connector

(76) Inventors: Shigehiro Morita, Tokyo (JP); Tatsuya Arai, Tokyo (JP)

Correspondence Address: Yusuke Takeuchi, KANESAKA & TAKEUCHI, 1423 Powhatan Street, Alexandria, VA, 22314, US

(21) Appl. No.: 09/782,205

(22) Filed: Feb. 14, 2001

(30) Foreign Application Priority Data
Feb. 15, 2000 (JP) 12-36303

(51) Int. Cl. H01R 24/00

(52) U.S. Cl. 439/941; 439/676

(57) ABSTRACT

A modular jack connector (21) that is mountable on a board (23) and comprises a plurality of terminals (26 and 26′) for contact with the terminals of a modular plug connector and a housing (25) including a plug cavity (28) for receiving the modular plug connector. The terminals (26) are electrically connected to the board (23) via a surface mount connector (24) that is soldered to the board.

### BACKGROUND OF THE INVENTION

1. Field of the Invention

The present invention relates to modular jack connectors into which modular plug connectors are plugged and, particularly, to a surface mount type modular jack connector that is mounted on the surface of a board.

2. Description of the Related Art

Connectors have been used in telephone equipment or local area network (LAN). One example is a modular jack connector. It usually is mounted on a board and plugged with a modular plug connector to which a cable or a plurality of core wires are connected.

FIG. 11 shows a conventional modular jack connector 1 mounted on a board 10. The connector 1 comprises a housing 2, a plurality of wire terminals 3 and 3′, a terminal holder 4 for holding the terminals 3 and 3′, and a shield sheet 5 for covering the housing 2. A plurality of plug cavities 6 and 6′ are arranged side-by-side in upper and lower rows so that a plurality of modular plug connectors (not shown) can be plugged into the plug cavities 6 and 6′ respectively.

The terminals 3 and 3′ are cantilevered and comprised of a resilient contact section 7 or 7′, a plug side section 8 or 8′ supported by the housing 2 and extending in the plugging direction of the modular plug connector, and a board side section 9 or 9′ extending downwardly from the plug side sections 8 or 8′. They are arranged in a direction perpendicular to the plane of the drawing (hereinafter “fist direction”) in the number corresponding to that of the plug connector; e.g., eight for each of the upper and lower tiers. When the plug connectors are fitted in the plug cavities 6 and 6′, the contact sections 7 and 7′ are brought into contact with the terminals of the plug connector so that the plug connectors are electrically connected to the jack connector 1. The board side sections 9 and 9′ are supported by the terminal holder 4 at regular intervals.

To mount the modular jack connector 1 on the board 10, the end portions 11 and 11′ of the board side sections 9 and 9′ are inserted into the attaching holes 12 of the board 10 and soldered to circuit traces of the board 10.

However, the terminals 3 and 3′ of the modular jack connector 1 must be arranged in a zigzag fashion to provide a predetermined distance between the terminals to not only prevent cross-talk but also provide a soldering space. For this reason, the depth of the modular jack connector is increased by that much, preventing miniaturization of the modular jack connector. Also, this zigzag arrangement makes it difficult to use a robot for automatic assembling. The end portions 11 and 11′ of the soldered terminals project from the board 10 limit arrangement design choices of electronics components to be mounted.

### SUMMARY OF THE INVENTION

Accordingly, it is an object of the invention to provide a surface mount modular jack connector that is compact and easy to assemble, and permits a wide range of arrangement designs of electronics components on the board.

According to the invention there is provided a modular jack connector to be mounted on a board that comprises a connector body including at least one plug cavity in at least one tier to receive a modular plug connector and at least one terminal for contact with at least one contact terminal of said modular plug connector; and a surface mount connector, wherein said terminal of said connector body is electrically connected to said board via said surface mount connector.

According to an embodiment of the invention, said terminal is directly connected to said surface mount connector. The terminals in said plug cavities in said tiers are integrated in every adjacent upper and lower tiers as a unit. Impedance match is made between plug and board side sections of said terminals.

According to another embodiment of the invention, the modular jack connector further comprises at least one connection board for connecting said at least one terminal and said surface mount connector. The terminals in all of the tiers are connected to the same connection board. The terminals in the tiers are connected to said connection boards; one tier for every connection board. The modular jack connector further comprises a shield layer deposited on said connection board and electrically connected to said shield plate that covers said housing. Impedance match is made in said connection board.

According to still another embodiment of the invention, the modular jack connector further comprises at least one flexible flat cable that connects said terminal and said surface mount connector. The terminals in all of said tiers are connected to said flat cable.

According to yet another embodiment of the invention, the terminals in said tiers are connected separately to said flat cables; one tier for each flat cable. The modular jack connector is made mountable on either side of said board.

### BRIEF DESCRIPTION OF THE DRAWINGS

FIG. 1 is a sectional view of a modular jack connector according to the first embodiment of the invention;

FIG. 2 is a sectional view of a modular jack connector according to the second embodiment of the invention;

FIG. 3 is a sectional view of a modification to the modular jack connector according to the second embodiment of the invention;

FIG. 4 is a sectional view of another modification to the modular jack connector according to the second embodiment of the invention;

FIG. 5 is a sectional view of still another modification to the modular jack connector according to the second embodiment of the invention;

FIG. 6 is a sectional view of yet another modification to the modular jack connector according to the second embodiment of the invention;

FIG. 7 is a sectional view of another modification to the modular jack connector according to the second embodiment of the invention;

FIG. 8 is a sectional view of a modular jack connector according to the third embodiment of the invention;

FIG. 9 is a sectional view of a modular jack connector according to the fourth embodiment of the invention;

FIG. 10 is a sectional view of a pair of modular jack connectors according to the second embodiment of the invention that are mounted on opposite sides of a board; and

FIG. 11 is a sectional view of a conventional modular jack connector.

### DESCRIPTION OF THE PREFERRED EMBODIMENTS

Embodiments of the invention will now be described with reference to the accompanying drawings.

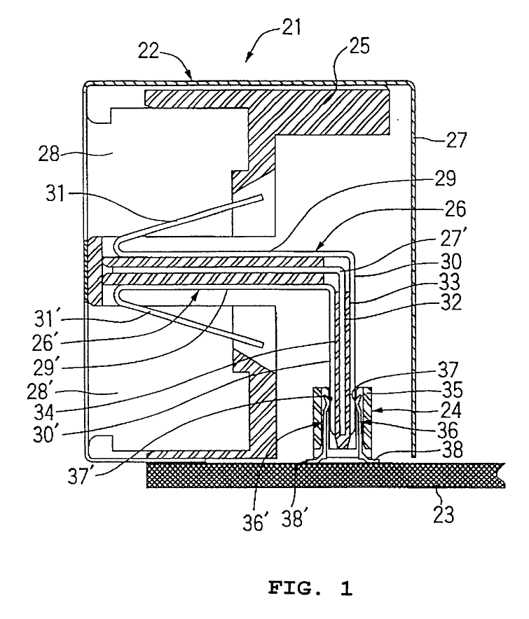

In FIG. 1, a modular jack connector 21 comprises a connector body 22 and a surface mount connector 24 to be mounted on a board 23. The connector body 22 comprises a housing 25 of an insulation material and a plurality of terminals 26 and 26′ provided in the housing 25. A shield plate 27 covers the housing 25 to shield noise from the outside. A shield plate 27′ is provided between the terminals 26 and 26′ to shield them.

A plurality of upper and lower plug cavities 28 and 28′ are arranged in the housing 25 in the first direction to receive modular plug connectors (not shown). Each upper terminal 26 has a plug side section 29 extending in the plugging direction along the bottom of the upper plug cavity 28, a board side section 30 extending downwardly from the plug side section 29, and a contact section 31 extending diagonally rearwardly from the plug side section 29. Each lower terminal 26′ has a plug side section 29′ extending along the ceiling of the lower plug cavity 28′ in the plugging direction, a board side section 30′ extending downwardly from the plug side section 29′, and a contact section 31′ extending diagonally rearwardly from the plug side section 29′. In this embodiment, eight contact sections 31 or 31′ are arranged in the upper or lower plug cavity 28 or 28′ in the first direction with a predetermined pitch corresponding to the terminals of a modular plug connector. Consequently, when a modular plug connector is plugged into the plug cavity 28 or 28′, the contact sections 31 or 31′ are brought into contact with the terminals of the modular plug connector to electrically connect the modular plug connector with the modular jack connector 21.

The eight board side sections 30 are arranged with a predetermined pitch in the first direction and bonded to a surface 33 of a core member 32 made of a sheet of an insulation material. The eight board side sections 30′ of the lower plug cavity 28′ are arranged in the first direction with a predetermined pitch and bonded to the other surface 34 of the core member 32. That is, 16 terminals 26 and 26′ of the upper and lower plug cavities 28 and 28′ are united by the core member 32, with the shield plate 27′ provided in the center of the core member 32.

The surface mount connector 24 extends in the first direction and has the form of a trench into or from which the lower portions of the board side sections 30 and 30′ are plugged or unplugged. It comprises a housing 35 of an insulation material and 16 contact terminals 36 and 36′ corresponding to the board side sections 30 and 30′. The upper portion of each contact terminal 36 or 36′ is bent to provide an inwardly convex contact section 37 or 37′ for holding the board side sections 30 or 31′ under a predetermined pressure to electrically connect the terminal 26 or 26′ with the contact terminal 36 or 36′. The lower portions of the contact terminals 36 and 36′ extend in opposite directions to provide leg sections 38 and 38′, which are mounted on a surface of the board 23 for electrical connection with predetermined traces of the board 23.

Since the terminals 26 and 26′ are united, simply by plugging the board side sections 30 and 30′ into the surface mounted connector 24, it is possible to connect the terminals 26 and 26′ to the surface mount connector 24. Not only impedance match is made between the plug side and board side sections 28, 29′ and 30, 30′ of the terminals 26, 26′ but also cross-talk is prevented. Since it is not necessary to separate the terminals 26 and 26′ at the predetermined distance, the depth of the modular jack connector 41 is reduced, making miniaturization of the modular jack connector possible.

How to mount the modular jack connector 21 on the board 23 will be described.

The surface mount connector 24 is placed on the board 23 at a predetermined circuit position by a robot (not shown) and the leg sections 38 and 38′ are soldered to predetermined circuit traces of the board 23 so that the surface mount connector 24 is not only electrically connected to the predetermined circuit traces but also mechanically fixed to the board 23. The surface mount connector 24 has such a size and weight that the robot can hold it, and the mounting operation can be made in the same direction relative to the board 23 so that it is easy to automate the mounting operation of the surface mount connector 24, thus making labor saving possible. Then, the lower portions of the board side sections 30 and 30′ are plugged into the surface mount connector 24 to electrically connect the connector body 22 to the surface mount connector 24. Since the contact sections 37 and 37′ of the surface mount connector 24 hold the terminals 26 and 26′ therebetween under the predetermined pressure, the connector body 22 is secured to the board 23 via the surface mount connector 24.

Alternatively, the upper and lower plug cavities 28 and 28′ may be replaced by a single tier or at least three tier plug cavities. Where the plug cavities are provided at least three tiers, it is preferred to unite the terminals 26 in every two adjacent tiers.

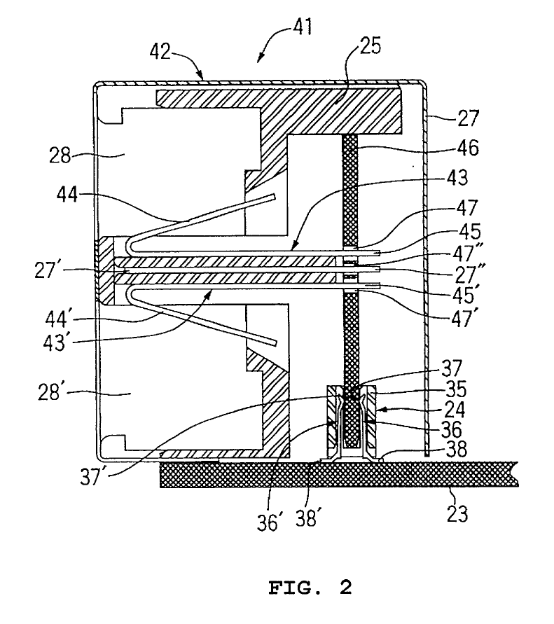

In FIG. 2, the second embodiment of the invention is shown, wherein the same or similar components to those of the first embodiment are assigned with the same reference numerals and their detailed description is omitted. A modular jack connector 41 comprising a connector body 42 and the surface mount connector 24. The connector body 42 comprising the housing 25 and a plurality of terminals 43 and 43′, and the shield plate 27 to cover the housing 25.

The terminals 43 and 43′ are arranged corresponding to the upper and lower plug cavities 28 and 28′ that are arranged in the first direction. Each upper terminal 43 has a horizontal section provided on the housing 25 and a cantilevered contact section 44 extending diagonally rearwardly. Each lower terminal 43′ has a horizontal section provided on the housing 25 and a contact section 44′ extending diagonally rearwardly. The shape of the terminal 43 and 43′ is so simple that there is no need for complicated bending work, resulting in the labor saving.

The other end portions 45 and 45′ of the terminal 43 and 43′ are inserted into the apertures 47 and 47′ of a connection board 46 and soldered to circuit traces of the connection board 46 for electrical connection. The connection board 46 extends in the first direction and a direction normal to the board 23 (hereinafter “second direction”), and the lower end portion thereof is pluggable into the surface mount connector 24. The predetermined circuit is provided on the connection board 46, and the contact terminals 36 and 36′ are provided in the surface mount connector 24 to hold the lower end portion of the connection board 46 under a predetermined pressure for electrical connection with the connection board 46. A shield plate 27′ is provided between the terminals 43 and 43′, with an end portion 27″ inserted into an aperture 47″ of the connection board 46 and soldered to a circuit trace of the connection board 46 for electrical connection.

The connection board 46 is plugged into the surface mount connector 24 for connection so that it is very easy to connect them. Not only impedance match of the terminals 43, 43′ and the connection board 46 is made but also the cross-talk is prevented. In addition, since the connection board 46 is thin, the depth of the modular jack connector 41 is reduced, resulting in the compact modular jack connector 41.

How to mount the modular jack connector 41 on the board 23 will be described.

The surface mount connector 24 is mounted on the board 23 by a robot (not shown) for electric connection with a predetermined circuit trace of the board 23. Then, the lower end portion of the connection board 46 is plugged into the surface mount connector 24 for electrical connection between the connector body 42 and the surface mount connector 24. Since the contact sections 37 and 37′ of the surface mount connector 24 hold the connection board 46 under the predetermined pressure so that the connector body 42 is secured to the board 23 via the surface mount connector 24.

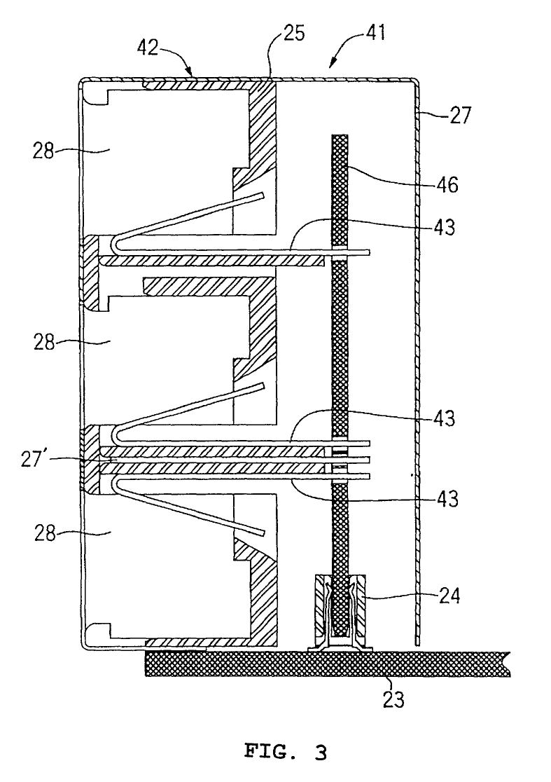

In FIG. 3, the upper and lower plug cavities 28 and 28′ of the second embodiment are replaced by three-tier plug cavities 28. Alternatively, they may be a single or at least four-tier plug cavities.

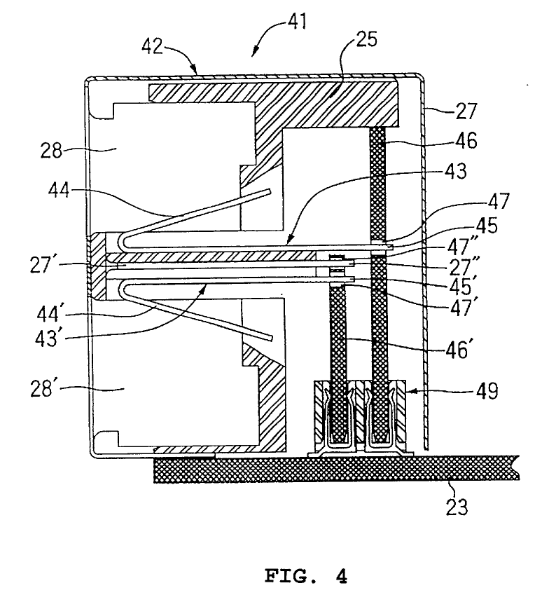

In FIG. 4, the terminals 43 and 431 are connected to separate connection boards 46 and 46′, respectively, and the shield plate 27′ is connected to only the connection plate 46′. The surface mount connector 49 is comprised of a pair of the surface mount connectors integrated as a unit.

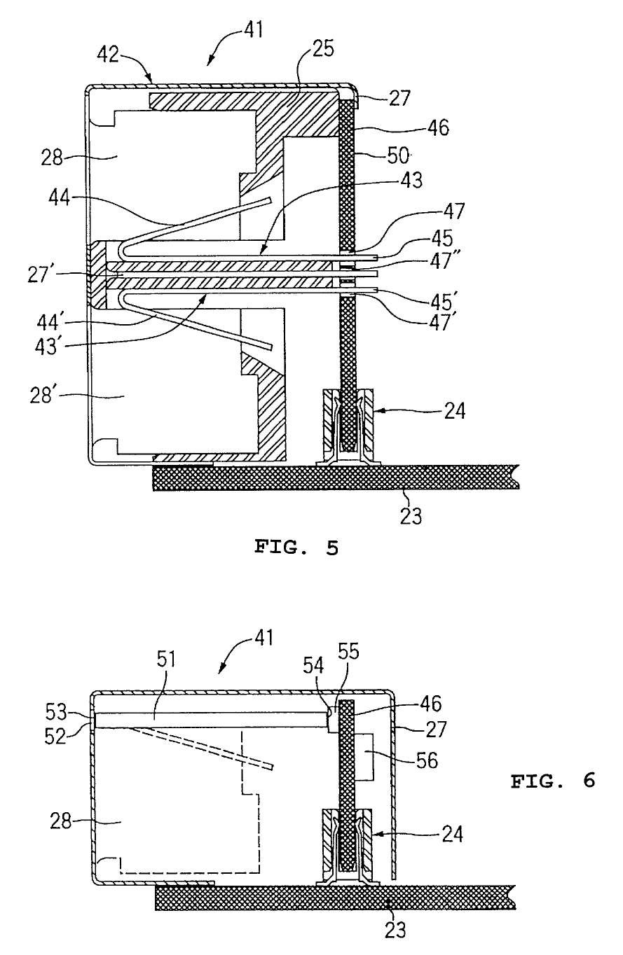

In FIG. 5, a shield layer 50 of copper or the like is deposited on the outside or inside of the connection board 46 and connected at the upper end with the shield plate 27 for ground connection. The portion of the shield plate 27 opposed to the connection board 46 may be omitted. Not only the depth of the modular jack connector 41 is reduced but also the ground connection is made easy. Where a plurality of the connection plates 46 are provided, the shield layer 50 may be deposited on only the outside of the outermost connection board.

Alternatively, the connection between the shield plate 27 and the shield layer 50 may be made by inserting an end of the shield plate 27 into a hole of the connection board 46 and soldering it to the connection board 46.

In FIG. 6, an indicator equipped connector displays light from a light source, such as a light emission diode (LED), to indicate plugging or signal receiving conditions of the modular jack connector from the modular plug connector. It comprises a light pipe 51 made of a transparent material, such as a transparent resin, and extends horizontally or in the plugging direction through the upper portion of the housing 25. An indicator opening 52 is provided at the upper portion of the plug cavity 28 to expose an end 53 of the light pipe 51. An LED 55 is mounted on the connection board 46 at a position opposed to and spaced from the other end 54 of the light pipe 51 and emits light horizontally toward the other end 54. The connection board 46 is removable so that it is easy to replace the LED 55. A noise filter 56 is surface mounted on the connection board 46 on the surface opposite to the LED for preventing interference by the noise. The light goes straight from the LED 55 to the outside through the light pipe 51 and the indicator opening 52. The noise produced within the circuitry is removed by the noise filter 56.

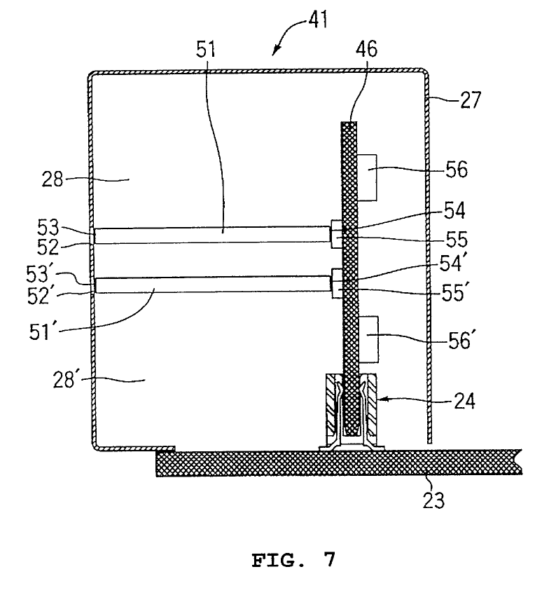

In FIG. 7, two-tier plug cavities 28 and 28′ are provided in contrast to the single-tier plug cavity 28 of FIG. 6.

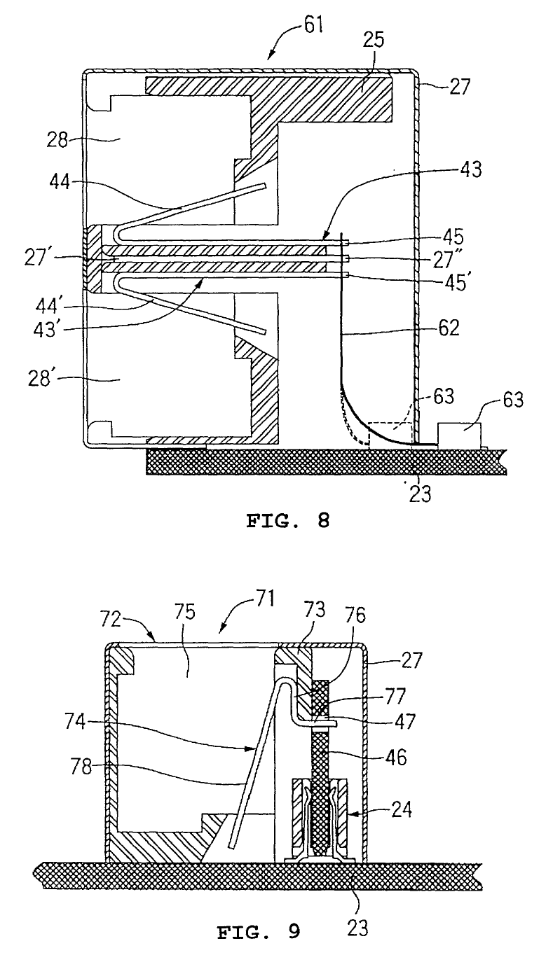

In FIG. 8, the third embodiment of the invention is shown, wherein the same or similar components to those of the first or second embodiment are assigned with the same reference numerals and their description is omitted. The end portions 45 and 45′ of terminals 43 and 43′ of a modular jack connector 61 are inserted into and electrically connected to a flat flexible cable 62. The end portion 27″ of the shield plate 27′ is also inserted into and electrically connected to the flexible cable 62. The lower portion of the flexible cable 62 is bent toward the outside of the shield plate 27 and electrically connected to a predetermined circuit trace of the board 23 via a surface mount connector 63. When the modular jack connector 61 is moved relative to the board 23, the flexible cable 62 absorbs the displacement to prevent the modular jack connector 61 or the board 23 from receiving an undesirable stress.

To mount the modular jack connector 61 on the board 23, the surface mount connector 63 is soldered to the board 23 by a robot (not shown) for electrical connection with a predetermined circuit trace and, then, the lower portion of the flexible cable 62 is connected to the surface mount connector 63.

Alternatively, the two-tier plug cavities 28 and 28′ may be replace by a single or at least three tiers of plug cavities. The surface mount connector 63 may be mounted on the board 23 inside of the shield plate 27 as shown by phantom line in FIG. 8. A portion of the shield plate 27 may be replaced by a shield layer that is deposited on the flexible cable 62 and connected to the shield plate 27 at the upper end.

In FIG. 9, the fourth embodiment of the invention is shown, wherein the same or similar components to those of the above embodiment are assigned with the same reference numerals and their description is omitted. A modular jack connector 71 comprises a connector body 72 and the surface mount connector 24. The connector body 72 comprises a housing 73, a plurality of terminals 74 provided in the housing 73, and the shield plate 27 to cover the housing 73. A plug cavity 75 is provided in the housing 73 to receive a modular plug connector (not shown) in the second direction.

The terminal 74 are arranged in the plug cavity 75 and each have a plug side section 76 extending in the plugging direction on the housing, a board side section 77 extending from the plug side section 76 in parallel to the board 23, and a cantilevered contact section 78 extending diagonally from the plug side section 76. The end portion of the board side section 77 is inserted into the hole 47 of the connection board 46 and electrically connected to a circuit trace of the connection board 46.

To mount the modular jack connector 71 on the board 23, the surface mount connector 24 is mounted on the board 23 by a robot (not shown) for electrical connection with a predetermined electrical circuit of the board 23 and, then, the lower end portion of the connection board 46 is plugged into the surface mount connector 24.

Alternatively, a shield layer of copper or the like may be deposited on the outside or inside of the connection board 46 and connected to the shield plate 27 for ground connection. The portion of the shield plate 27 opposed to the connection board 46 may be omitted, making not only reduction of the depth of the modular jack connector 71 possible but also the ground connection easy.

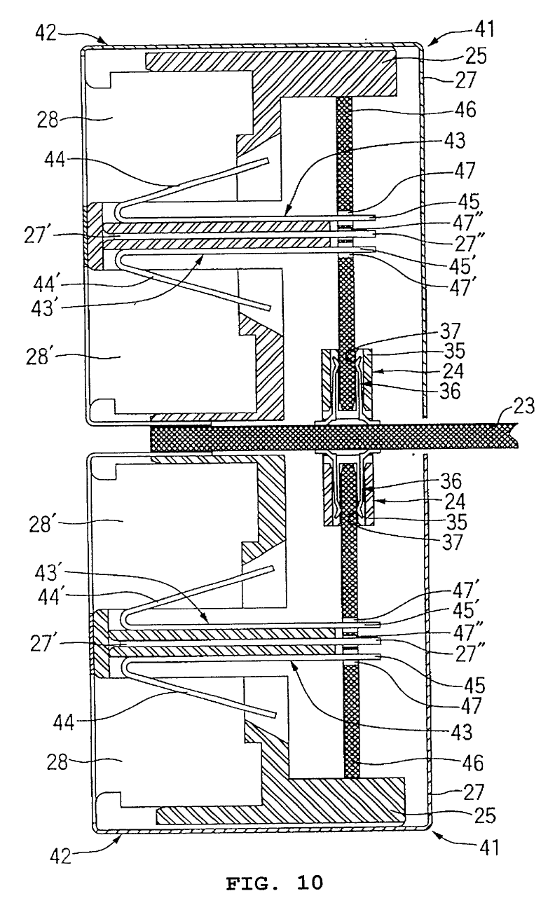

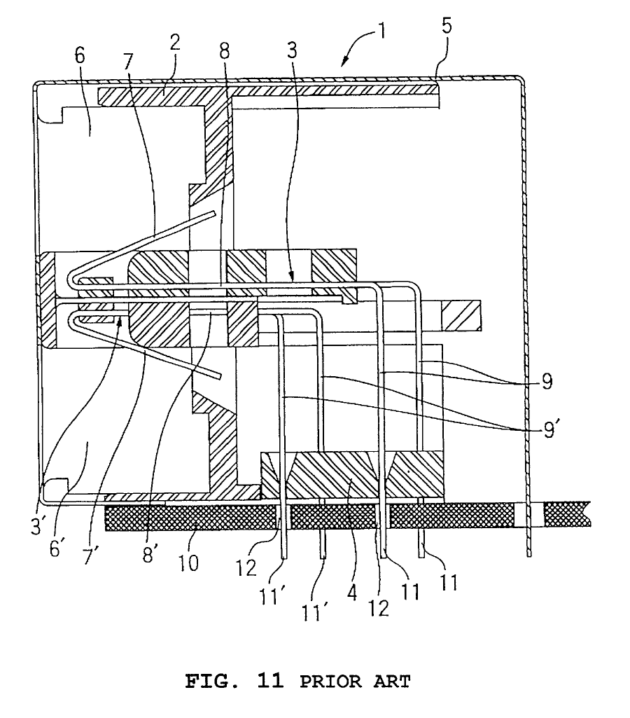

In FIG. 10, a plurality of modular jack connectors 41 of the first, second, third, or fourth embodiment are surface mounted on both sides of the board 23 at positions symmetric relative to the board 23, for example. The number of terminals 26, 43, or 74 is not limited to the above illustrated embodiments.

According to the invention, it is unnecessary to directly solder respective terminals to the board or space the terminals at a certain distance, making it possible to reduce the depth of the modular jack connector by that much, resulting in the compact modular jack connector. The modular jack connector can be mounted on the surface of a board so that there are many choices in circuit design for the modular jack connector or the other electronics components.

1. A modular jack connector mountable on a board, comprising:
a connector body including at least one plug cavity in at least one tier to receive a modular plug connector and at least one terminal for contact with at least one contact terminal of said modular plug connector; and
a surface mount connector, wherein
said at least one terminal of said connector body is electrically connected to said board via said surface mount connector.

2. A modular jack connector according to claim 1, wherein said at least one terminal is directly connected to said surface mount connector.

3. A modular jack connector according to claim 2, wherein a plurality of said terminals in a plurality of said plug cavities are integrated in adjacent upper and lower tiers as a unit.

4. A modular jack connector according to claim 2 or 3, wherein impedance match is made between plug and board side sections of said at least one terminal.

5. A modular jack connector according to claim 1, which further comprises at least one connection board for connecting said at least one terminal and said surface mount connector.

6. A modular jack connector according to claim 5, wherein said terminals in a plurality of said tiers are connected to said connection board.

7. A modular jack connector according to claim 5, wherein said terminals in a plurality of said tires are connected to a plurality of said connection boards; one tier for each connection board.

8. A modular jack connector according to claim 5, 6, or 7 which further comprises a shield layer deposited on said at least one connection board and electrically connected to said shield plate that covers said housing.

9. A modular jack connector according to claim 5, 6, or 7, wherein impedance match is made in said connection board.

10. A modular jack connector according to claim 1, which further comprises at least one flexible flat cable that connects said at least one terminal and said surface mount connector.

11. A modular jack connector according to claim 10, wherein said terminals in a plurality of said tiers are connected to said flat cable.

12. A modular jack connector according to claim 10, wherein said terminals in a plurality of said tiers are connected to a plurality of said flat cables; one tier for each flat cable.

13. A modular jack connector according to claim 1, 5, or 10, wherein said modular jack connector is mountable on either side of said board.
